(19) United States
(12) Patent Application Publication
(10) Pub. No.: US 2025/0036406 A1
(43) Pub. Date: Jan. 30, 2025

(54) METHOD FOR EXECUTING A FUNCTION CALL, SYSTEM AND COMPUTER-READABLE MEDIUM

(71) Applicant: CARIAD SE, Wolfsburg (DE)

(72) Inventor: Hans Georg GRUBER, Wolfsburg (DE)

(21) Appl. No.: 18/780,313

(22) Filed: Jul. 22, 2024

(30) Foreign Application Priority Data
Jul. 25, 2023 (DE) 10 2023 119 583.2

(51) Int. Cl. G06F 9/30; G06F 15/78

(52) U.S. Cl. CPC G06F 9/30003; G06F 15/7807

(57) ABSTRACT

A method for executing a function call includes: receiving a function call that identifies at least one function, providing an instruction packet that includes a list of main chip functions executable by a main chip, determining whether the at least one function identified by the function call is included in the list of the main chip functions included in the instruction packet and/or can be composed of the main chip functions, and executing the function call. Furthermore, the disclosure relates to a system, and a computer-readable medium.

### BACKGROUND

### Technical Field

The disclosure relates to a method for executing a function call, a system and a computer program product.

### Description of the Related Art

In modern computer systems tasks are often carried out by specialized computing units, also referred to as processors or chips. For example, specific chips may be provided for tasks such as calculating graphics, simulation, artificial intelligence or processing position sensor data. However, the results of the calculations are usually executed by a central processing unit that queries the results and processes them further.

In modern computer systems, this parallel processing is becoming increasingly important to increase performance and efficiency. Although the integration of main and accelerator processors offers many advantages, it also creates challenges, if this components should work together. In particular the coordination and synchronization of the various processors proves regularly as demanding.

A major problem arises from the different architectures and properties of main and accelerator processors. Main processors are usually designed for general purposes and offer high flexibility for a wide range of tasks. On the other hand, accelerator processors are specialized units, which have been optimized for specific computationally intensive tasks.

The cooperation of these two types of processors requires a seamless integration and efficient communication. Various memory access patterns, processing speeds and command sets can lead to inefficiencies and affect the performance of the overall systems.

In addition, problems in connection with programming and operation may occur. Developing applications that take advantage of parallel processing often requires special knowledge and resources. Programming and optimizing software for a heterogeneous processor architecture can be complex and time-consuming. Also, suitable communication mechanisms must be implemented to exchange data between the various processors efficiently.

Furthermore, there may be also delays and latency times in the communication between main and accelerator processors. As a result of these delays the expected performance benefits of the accelerator processors cannot be completely utilized and thus the overall performance of systems is affected.

### BRIEF SUMMARY

It is therefore an object of the present disclosure to overcome at least one of the disadvantages described above at least partially. In particular, it is an object of the disclosure to provide a method for executing a function call, a system and a computer program product in which the execution of a function is accelerated, programming is simplified and costs are reduced.

Here, features and details which are described in connection with the method according to the disclosure, also apply, of course, in connection with the system according to the disclosure and/or in connection with the computer program product according to the disclosure, and vice versa in each case, so that with reference to the disclosure of the individual aspects of the disclosure there is or can be always mutual reference to one another.

According to the disclosure, provision is made for a method for executing a function call, comprising:
receiving a function call, comprising at least one function, in particular by the main chip,
providing an instruction packet, wherein the instruction packet includes a list of main chip functions executable by a main chip, in particular by the main chip,
determining, whether the at least one function of the function call is included in the instruction packet and/or can be composed of the main chip functions, in particular by the main chip, and
executing the function call, in particular by the main chip.

In other words, a process for executing a function call may be provided, which comprises receiving an instruction to call a function and providing an instruction set architecture (ISA), wherein the instruction set architecture specifies which commands can be executed by a main processor. The process further comprises identifying, whether the instruction is part of the Instruction Set Architecture and/or whether the instruction can be composed of one or more commands of the Instruction Set Architecture, and starting the instruction.

The method steps can run at least partially at the same time and/or consecutively, wherein the sequence of the method steps is not limited by the specified sequence, so that individual steps can be carried out in a different sequence. Furthermore, individual or all steps can be carried out repeatedly.

The method can be designed as a computer-implemented method.

In the context of the disclosure, a function call can be understood to mean a process that enables a program to call a function and/or a subroutine. A function can comprise a specified subsequence of instructions that performs a particular task and in particular accepts parameters and/or delivers a return value.

Receiving a function call can be understood to mean an instruction to the main chip to execute a particular function. Depending on the architecture of the main chip, various methods may be provided how to configure a function call. The function call can be designed at least as a call instruction, processing a stack, linking in a link register, or jumping in a jump table.

In the context of the disclosure, an instruction packet can be understood as an Instruction Set Architecture (ISA). The instruction packet can be designed to specify an interface between the hardware and the software. The instruction packet may comprise an abstract description of a main chip that defines at least the instructions, registers, addressing modes, or memory organization supported by that main chip.

The instruction packet may be an ISA documentation, in particular, provided by a main chip manufacturer and/or a body that supports the ISA. Furthermore, the instruction packet may comprise the functions found in an ISA documentation and may configured in such a way, that the main chip can be used to determine, whether a function is part of the instruction packet. In a simple case, this can be implemented as a search for a string, for example.

The instruction packet can in particular be designed as Instruction Set Architecture for an x86, an ARM, a Reduced Instruction Set Computer (RISC), a Microprocessor without Interlocked Pipeline Stages (MIPS), a Graphics Processing Unit (GPU), a Digital Signal Processor (DSP) or a machine learning application-specific integrated circuit (ML ASIC).

Providing an instruction packet may comprise storing the instruction packet in a memory accessible to the main chip and/or a memory of the main chip.

Determining whether the at least one function of the function call is included in the instruction packet and/or can be composed of the main chip functions can be understood as an analysis that can be carried out by the main chip, in which the function is searched for in the instruction packet and/or one or more functions corresponding to said function are searched for in the instruction packet. Provision can be made, that said determining comprises dividing the function into subfunctions and/or combining and/or dividing functions of the instruction packet. A simple example would be dividing a multiplication function into several addition functions. Provision can therefore be made to provide an instruction packet function that corresponds to the function in the instruction packet and/or is composed of at least two functions which are included in the instruction packet and, when composed, correspond to the function.

Executing the function call can be understood as initiating the steps that are executed to execute the function, in particular on the main chip. Provision can be made that the function call calls the functions included in the instruction packet and/or those that can be composed of the main chip functions. In other words, the previously determined functions are called. In other words, the instruction packet function is called.

The exact configuration of the function call strongly depends on the architecture of the main chip. Provision can be made that the execution of the function call further comprises the transfer of parameters, a jump to the function, the execution of the function, the reading of a return value of the function and a continuation of a program.

Provision can also be made that one or more functions provided for an accelerator chip are at least partially replaced by functions of the main chip. This simplification means that high-cost accelerator chips, in particular ML accelerators, can be dispensed with or they can be used in smaller quantities or in more cost-effective variants.

Provision can also be made that functions that are part of an instruction packet for an accelerator chip are added to the instruction packet. This has the advantage that even commands that were not originally executable by the main chip can be performed directly by said main chip, so that accelerator chips can be dispensed with in whole or in part.

Overall, the method according to the disclosure offers the advantage that the execution of a function is accelerated, programming is simplified and costs are reduced. Receiving a function call is the reason for calling a function. By providing an instruction packet the functions stored there can be accessed. By determining whether said at least one function of the function call is included in the instruction packet and/or can be composed of the main chip functions, the function is analyzed based on the instruction packet and thus, advantageously, it can be determined, whether the function actually requires a special, wide accelerator chip or can be executed on the main chip directly. Executing the function call offers the advantage that the function is executed directly on the main chip, as appropriate, thus being able to avoid delays caused by communication with one or more accelerator chips. In particular, the use of accelerator chips can possibly be avoided altogether, thus reducing costs. For programmers it becomes easier to work with the main chip, since no or fewer commands need to be provided for communication between the chips. In other words, it avoids the main chip being stalled by calls to accelerator chips and the programmers being forced to switch to other tools and programming models. The method according to the disclosure integrates the function calls into the ISA, so that the programmers can utilize the additional functions with the same programming model.

In the context of the disclosure it can be advantageous if provision is made for a function call to be executed on an accelerator chip, wherein the function call comprises at least one special function, wherein the special function is not included in the instruction packet and/or cannot be composed of the main chip functions. This has the advantage that even in the unfavorable case that the function call is not completely included in the instruction packet and/or cannot be composed of several functions of the instruction packet, the function remains nonetheless executable.

In the context of the disclosure, it is conceivable that executing the function call on the accelerator chip takes place in parallel and/or after executing the function call on the main chip. This has the advantage that, in parallel execution, an acceleration of program sequences in total becomes possible, in particular when the main chip executes other functions or instructs other accelerator chips to execute functions during the call by the accelerator chip. By executing the function call on the accelerator chip after the function call on the main chip, advantageously, the accelerator chip does not hold up the main chip, for example through queries or sending a result.

In the context of the disclosure, provision can be made that the main chip communicates with the accelerator chip via an interprocessor communication protocol, wherein, in particular, the interprocessor communication protocol is integrated into the main chip. This has the advantage that the main chip can communicate efficiently with the accelerator chip. In particular, the integration of the interprocessor communication protocol into the main chip simplifies the programmability and the actual calling of functions via the interprocessor communication protocol.

It is also conceivable that the function call comprises at least one function that is provided for an execution on an accelerator chip. This has the advantage that a function originally provided for an accelerator chip can be found in the instruction packet of the main chip and/or accordingly can be composed of one or more functions, so that also an execution by the main chip is made possible.

The above object is further achieved by a system according to the disclosure for executing a method for executing a function call, in particular according to any one of the preceding claims, comprising a main chip designed to,
receive a function call, comprising at least one function,
provide an instruction packet, wherein the instruction packet includes a list of main chip functions executable by the main chip,
determine, whether the at least one function of the function call is included in the instruction packet and/or can be composed of the main chip functions, and
execute the function call.

Thus, a system according to the disclosure has the same advantages as have been described in detail with reference to a method according to the disclosure.

Also it is conceivable that further provision is made for an accelerator chip which is designed to execute a special function included in the function call, wherein the special function is not included in the instruction packet and/or cannot be composed of the main chip functions. The accelerator chip therefore has the advantage that, despite the not resolvable functions, nonetheless the functionality of the system in total is preserved.

In the context of the disclosure, it is optionally possible for the main chip and/or the accelerator chip to be designed at least as CPU, GPU, DSP or ASIC, in particular Machine Learning ASIC. A CPU offers the advantage that it is designed for a variety of tasks and supports a variety of applications. CPUs have typically a high single thread performance and can thus provide the execution a single thread or a single task with high performance. They offer good performance for sequential, not highly parallelizable tasks. GPUs offer the advantage that they are designed to process many tasks simultaneously and have been optimized for this purpose. They have a high number of kernels allowing parallel processing of large amounts of data. As a result, they are ideally suited for computationally intensive, parallelizable tasks such as graphics processing, simulations, and cryptocurrency mining. In addition, GPUs typically have high memory bandwidth, which is beneficial for high-throughput tasks such as, for example, training neuronal networks. A DSP is optimized for signal processing and offers high computing power and efficiency for tasks such as audio processing, image processing, speech recognition and communication systems. This allows signals to be processed in real time and results to be provided quickly. ASICs offer particularly high performance and efficiency because they are specifically developed for a specific application and optimized. They can access specific hardware structures and functions that are tailored to the application and therefore generally have lower energy consumption than other, non-specialized chips. In large quantities, they can also be produced in a particularly cost-effective manner. Machine Learning ASICs are specifically developed for the acceleration of machine learning algorithms and therefore offer the advantage that machine learning-specific functions, especially matrix operations, can be performed particularly quickly and energy-efficiently

Furthermore, in the context of the disclosure, provision can be made that the CPU is designed at least as x86, Arm, RISC-V or MIPS. x86, in particular Intel processors, offer the advantage of having broad support and compatibility. The large selection of software and developer tools developed specifically for x86 processors facilitates the utilization by programmers. In addition, x86 processors typically offer high single thread performance. An ARM-CPU is characterized by its energy efficiency. Because of the good performance/consumption ratio, ARM CPUs can also be used in battery-powered systems, especially in mobile devices, embedded systems and IoT devices. RISCs, especially RISC-V chips have a comparatively simple command set architecture, which reduces the implementation effort and increases the execution speed. Also RISC CPUs have a low power consumption and work more energy efficiently than more complex processors such as x86. MIPS also offer a simple and efficient command set architecture that enables fast command decoding.

The above object is further achieved by a computer program product according to the disclosure, comprising commands which, when the program is executed by a computer, in particular by a system according to the disclosure, will cause the computer to execute a method according to the disclosure.

Thus, a computer program product according to the disclosure has the same

advantages as have been described in detail with reference to a method according to the disclosure and/or a system according to the disclosure.

### BRIEF DESCRIPTION OF THE SEVERAL VIEWS OF THE DRAWINGS

Further advantages, features and details of the disclosure emerge from the following description which describes in detail several exemplary embodiments of the disclosure with reference to the drawings. The features mentioned in the claims and in the description may be essential to the disclosure, either individually or in any combination. The disclosure is shown in the following figures, where:

FIG. 1 shows a schematic overview of a method according to the disclosure, and

FIG. 2 shows a schematic overview of a system according to the disclosure.

In the following figures, same reference numerals are used for the same technical features, also for different exemplary embodiments.

### DETAILED DESCRIPTION

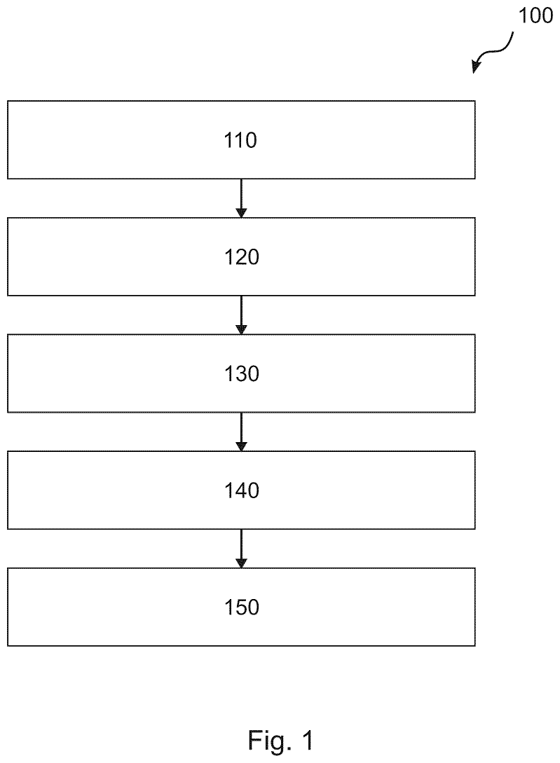

FIG. 1 shows a method 100 according to the disclosure for executing a function call, comprising:
receiving 110 a function call, comprising at least one function,
providing 120 an instruction packet, wherein the instruction packet includes a list of main chip functions executable by a main chip 210,
determining 130, whether the at least one function of the function call is included in the instruction packet and/or can be composed of the main chip functions, and
executing 140 the function call.

Overall, the method 100 according to the disclosure offers the advantage that the execution of a function is accelerated, programming is simplified and costs are reduced. Receiving 110 a function call is the reason for calling a function. By providing 120 an instruction packet the functions stored there can be accessed. By determining 130 whether said at least one function of the function call is included in the instruction packet and/or can be composed of the main chip functions, the function is analyzed based on the instruction packet and thus, advantageously, it can be determined, whether the function actually requires a special, wide accelerator chip 220 or can be executed on main chip 210 directly. Executing the function call offers the advantage that the function is executed directly on main chip 210, as appropriate, thus being able to avoid delays caused by communication with one or more accelerator chips 220. In particular, the use of accelerator chips 220 can possibly be avoided altogether, thus reducing costs. For programmers it becomes easier to work with the main chip 210, since no or fewer commands need to be provided for communication between the chips. In other words, it avoids the main chip 210 being stalled by calls to accelerator chips 220 and the programmers being forced to switch to other tools and programming models. The method 100 according to the disclosure integrates the function calls into the ISA, so that the programmers can utilize the additional functions with the same programming model.

Furthermore, provision can be made for a function call to be executed 150 on an accelerator chip 220, wherein the function call comprises at least one special function, wherein the special function is not included in the instruction packet and/or cannot be composed of the main chip functions. This has the advantage that even in the unfavorable case that the function call is not completely included in the instruction packet and/or cannot be composed of several functions of the instruction packet, the function remains nonetheless executable.

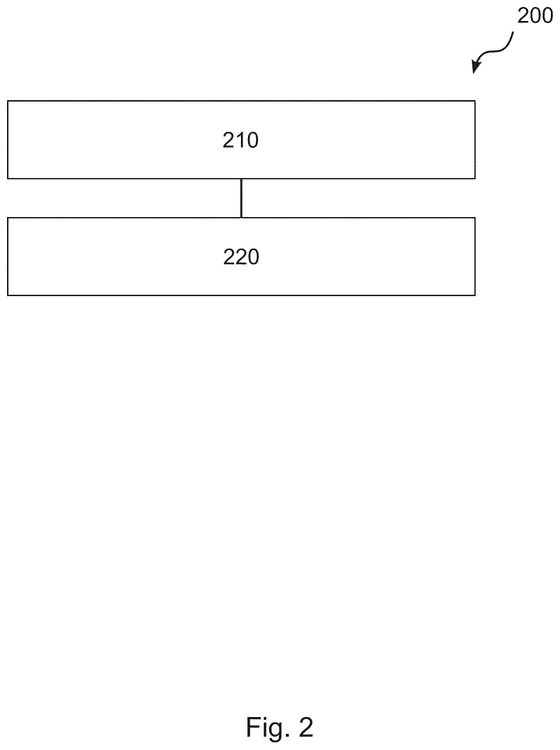

FIG. 2 shows a system 200 according to the disclosure for executing a method 100 for executing a function call, in particular a method 100 according to the disclosure, comprising a main chip 210 designed to
receive 110 a function call, comprising at least one function,
provide 120 an instruction packet, wherein the instruction packet includes a list of main chip functions executable by the main chip 210,
determine 130, whether the at least one function of the function call is included in the instruction packet and/or can be composed of the main chip functions, and
execute 140 the function call.

Thus, a system according to the disclosure has the same advantages as have been described in detail with reference to a method according to the disclosure.

The preceding explanation of the embodiments describes the present disclosure exclusively in the context of examples. Of course, individual features of the embodiments can be freely combined with each other, provided that this is technically feasible, without departing from the scope of the present disclosure.

German patent application no. 10 2023 119 583.2, filed Jul. 25, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for executing a function call, comprising:
receiving a function call that identifies at least one function;
providing an instruction packet that includes a list of main chip functions executable by a main chip;
determining whether the at least one function identified by the function call is included in the list of the main chip functions included in the instruction packet and/or can be composed of the main chip functions; and
executing the function call.

2. The method according to claim 1, wherein the executing includes executing the function call on an accelerator chip, wherein the function call identifies at least one special function, and wherein the special function is not included in the instruction packet and/or cannot be composed of the main chip functions.

3. The method according to claim 2, wherein the executing the function call takes place on the accelerator chip parallel in time and/or after executing the function call on the main chip.

4. The method according to claim 2, further comprising:
communicating, by the main chip, with the accelerator chip via an interprocessor communication protocol that is integrated into the main chip.

5. The method according to claim 1, wherein the function call identifies at least one function that is provided for execution on an accelerator chip.

6. A system that executes a function call, the system comprising:
a main chip including:
a processor; and
a memory storing a program that, when executed by the processor, cause the main chip to:
receive a function call that identifies at least one function;
provide an instruction packet that includes a list of main chip functions executable by the main chip;
determine whether the at least one function identified by the function call is included in the list of the main chip functions included in the instruction packet and/or can be composed of the main chip functions; and
execute the function call.

7. The system according to claim 6, further comprising:
an accelerator chip that, in operation, executes a special function identified by the function call, wherein the special function is not included in the instruction packet and/or cannot be composed of the main chip functions.

8. The system according to claim 6, wherein the main chip and/or the accelerator chip are/is a Central Processing Unit (CPU), a Graphics Processing Unit (GPU), a Digital Signal Processor (DSP), or an Application Specific Integrated Circuit (ASIC).

9. The system according to claim 8, wherein the ASIC is a Machine Learning ASIC.

10. The system according to claim 8, wherein the CPU has an x86 architecture, an ARM architecture, a Reduced Instruction Set Computer, fifth version (RISC-V) architecture, or a Microprocessor without Interlocked Pipeline Stages (MIPS) architecture.

11. A non-transitory computer-readable medium storing a program that, when executed by a processor, causes a computer to:
receive a function call that identifies at least one function;
provide an instruction packet that includes a list of main chip functions executable by the main chip;
determine whether the at least one function identified by the function call is included in the list of the main chip functions included in the instruction packet and/or can be composed of the main chip functions; and
execute the function call.
